(19) United States
(12) Patent Application Publication
(10) Pub. No.: US 2015/0324574 A1
(43) Pub. Date: Nov. 12, 2015

(54) SERVER DEVICE, SOFTWARE PROGRAM, AND SYSTEM

(71) Applicant: DeNA Co., Ltd., Tokyo (JP)

(72) Inventor: Sota MIZUSHIMA, Tokyo (JP)

(21) Appl. No.: 14/706,303

(22) Filed: May 7, 2015

(30) Foreign Application Priority Data
May 9, 2014 (JP) 2014-097263

(51) Int. Cl. G06F 21/44; H04L 29/06

(52) U.S. Cl. CPC G06F 21/44; H04L 67/42; G06F 2221/2117

(57) ABSTRACT

A server 10 that provides a predetermined service to user terminals 50 over a network 60 registers a user in response to a registration request addressed from a user terminal 50 to the above-mentioned service, and, at the time of registration, generates content information used for re-registration and transmits it to the user terminal 50 while determining whether or not re-registration should be performed by matching content information transmitted from a given terminal against the generated content information.

The present application claims the benefit of Japanese Patent Application No. JP2014-097263, filed on May 9, 2014, the contents of which is incorporated herein in its entirety by reference.

### BACKGROUND

1. Technical Field

The present invention relates to a server device, a software program (e.g., non-transitory computer readable media having machine-executable instructions to operate a computer having a storage and a hardware processor connected via a network to a terminal device), and a system that provide gaming and other services, for example, over a network.

2. Related Art

Network-enabled game services and SNS services allowing multiple users to participate over a network have proliferated in recent years. Communication with a server device belonging to a service operator using PC (Personal Computer) terminals, mobile terminals, and other information processing devices makes it possible to engage in communication with other users or cooperate with them to play a game.

A technique has been disclosed for use with such services, whereby the process to log in to a service is implemented by transmitting a login ID code from a service operator's server device to a user terminal and configuring a password at the terminal side (for example, see Patent Citation 1). In addition, a technique has been disclosed in which user e-mail addresses are registered as ID codes in a server device, thereby enabling login based on e-mail addresses alone and reducing the likelihood of losing or forgetting ID codes (for example, see Patent Citation 2).

### PRIOR-ART DOCUMENT

### Patent Document

### [Patent Document 1]

Japanese Patent Application Publication No. 2010-033385.

### [Patent Citation 2]

Japanese Patent Application Publication No. 2006-109440.

### SUMMARY OF THE INVENTION

### Problems to be Solved by the Invention

However, since the e-mail address changes when switching to a terminal associated with a different communications operator, there have been cases in which an e-mail address is forgotten. In addition, there are services that don't even require an e-mail address to be registered, and so users have been frequently registered in association with their terminal devices themselves, and there have been cases in which the process of re-registration with the service is unsuccessful if a user changes terminals or tries to log in using another of their own terminals.

### SUMMARY

The present invention has been devised by taking such problems into consideration and it is an object to the invention to provide a server device, a software program (e.g., non-transitory computer readable media having machine-executable instructions to operate a computer having a storage and a hardware processor connected via a network to a terminal device), and a system that can re-register existing registered users in a simple and easy manner.

### Means for Solving the Problems

In one aspect, the present invention is a server device. This server device, which provides a predetermined service to user terminals over a network, is equipped with: a user registration module that registers a user in response to a registration request addressed from the user's terminal to the service; a re-registration content generation module that generates content information used for re-registration during registration in the user registration module; a memory that stores the content information generated by the re-registration content generation module; a communication module that transmits the content information generated by the re-registration content generation module to the terminal of the user associated with the registration request; and a re-registration determination module that determines whether or not re-registration should be performed by matching content information transmitted from a given terminal against content information stored in memory. Here, if the re-registration determination module makes a determination to the effect that re-registration should be performed, the user registration module registers the user associated with the transmitted content information.

According to this aspect, the re-registration process is carried out using content information and, for this reason, even if the user loses the registration information, or logs in to the registered service from another terminal device, the process of re-registration with the service can be implemented in a simple and easy manner.

It should be noted that any combinations of the above-mentioned constituent elements and aspects, as well as subject matter produced by converting the wording of this invention to methods, apparatus, systems, computer programs, and the like, are valid as aspects of the present invention.

### Effects of the Invention

The present invention can provide a server device, a method, a software program (e.g., non-transitory computer readable media having machine-executable instructions to operate a computer having a storage and a hardware processor connected via a network to a terminal device), and a system that allow for user registration to be completed in a simple, easy, and safe manner, without requiring laborious input operations.

### BRIEF DESCRIPTION OF THE DRAWINGS

FIG. 1 A diagram illustrating an exemplary configuration of the system according to Embodiment 1.

FIG. 2 A diagram illustrating an exemplary configuration of the mobile terminals or PC terminal of FIG. 1.

FIG. 3 A diagram illustrating an exemplary configuration of the server of FIG. 1.

FIG. 4 A diagram illustrating an example of the stored contents of the server memory of FIG. 3.

FIG. 5 A diagram illustrating an example of image content information generated by the re-registration content generation module of FIG. 3.

FIG. 6 A sequence diagram illustrating an exemplary processing procedure of the system of FIG.

FIG. 7 A diagram illustrating an exemplary user registration screen of the user terminal of FIG. 1.

### DETAILED DESCRIPTION

### Summary of the Invention

First of all, before describing the embodiments of the present invention, a summary of the present invention will be provided. The present invention relates to a network-based service-providing system, in particular, to a server device that provides a game service or an SNS service over the Internet.

Game services, for example, have a mechanism for account registration that allows for registration to be completed in a simple and easy manner without requiring e-mail addresses or passwords. However, due to such simplicity, users tend to misplace or forget (lose) such accounts when changing terminals and so forth.

In such cases, users don't remember the user ID of their account and have to give up on restoring their account. Thus, it is an object of the present invention to provide a mechanism that would make restoring an account possible even under the above-mentioned circumstances by issuing accounts in the form of content information and storing them in terminals. By storing accounts as content information and by ascertaining the availability of content listing functionality, which is installed on most terminals, users can recognize and differentiate account information in a simple and easy manner, thereby facilitating re-registration with the service.

It should be noted that while the discussion below assumes that the content used for re-registration is an “image”, it goes without saying that this need not be the case, and similar action and effects can be obtained using information that includes binary data, such as audio, video, and the like. In addition, when using image content, improvements in security can also be obtained because completely identical images are believed to be difficult to generate by means other than copying.

### Embodiment 1

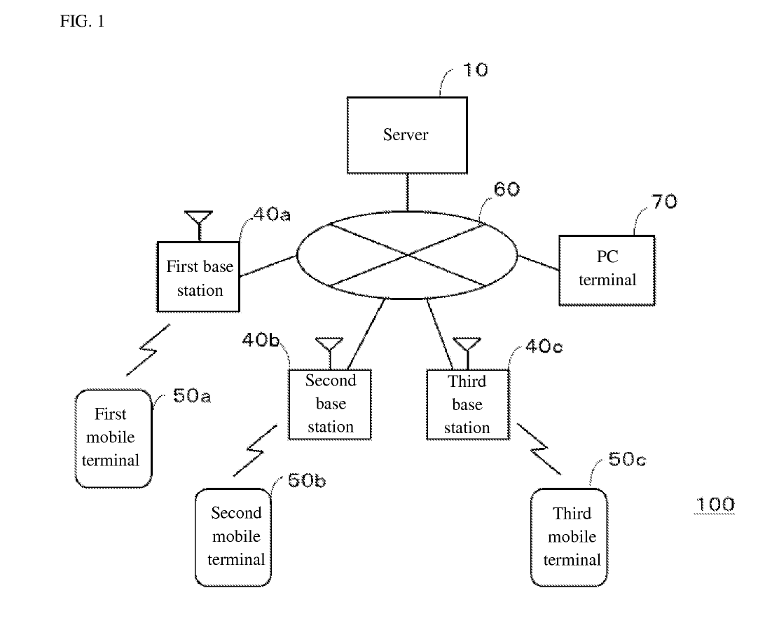

FIG. 1 is a diagram illustrating a system 100 according to Embodiment 1 of the present invention. The system 100 includes: a server 10, a network 60, which connects the server 10 and base stations 40 through wired connections, first base station 40a through third base station 40c, which are represented as base stations 40; first mobile terminal 50a through third mobile terminal 50c, which are represented as mobile terminals 50, and a PC terminal 70. The mobile terminals 50 include, for example, a feature phone, a smartphone, a tablet computer terminal, or the like.

In this system 100, predetermined services are provided by the server 10 to the PC terminal 70 through the network 60, or to the mobile terminals 50 through the network 60 and the base stations 40. These services include, for instance, game services provided via SNS, or services utilizing game applications downloaded to the terminals from an application-providing platform. The application-providing platform may be integrated with the server 10 or provided by another server.

In order to ensure that the number of users registering with these services increases, this system 100 may be equipped with functionality that users registered with the service (invitor users) use to invite unregistered users (invitee users). When an invitee user registers with the service, benefits that can be used in said service may be provided to the invitor user (terminal) and/or the invitee user (terminal). When an invitation is issued, image content used for re-registration may be used to verify the invitee user (terminal).

It should be noted that while only three base stations 40 and mobile terminals 50 are depicted in the drawing for the convenience of illustration, this need not be the case, and there may be more base stations 40 and mobile terminals 50. The same applies to the PC terminal 70. In addition, while the mobile terminals (i.e. first mobile terminal 50a through third mobile terminal 50c) are illustrated as connected to respectively different base stations 40, this need not be the case, and it goes without saying that the present invention is applicable even if multiple mobile terminals 50 are connected to a single base station 40. In addition, the base stations 40 may constitute access points, such as a wireless LAN, or the like. Below, the mobile terminals 50 and the PC terminal 70 are collectively referred to as “user terminals”.

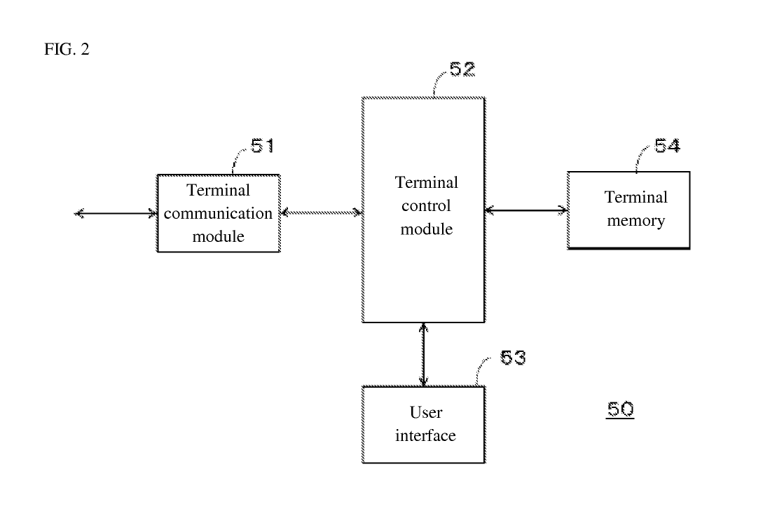

FIG. 2 is a diagram illustrating an exemplary configuration of a user terminal. Although the configuration of the mobile terminal 50 will be discussed here for purposes of convenience, the same configuration is used for the PC terminal 70. The mobile terminal 50 is provided with a terminal communication module 51, a terminal control module 52, a user interface 53, and a terminal memory 54.

The terminal communication module 51 executes communications with the server 10. For example, in addition to receiving application programs from the server 10, as well as transmitting signals related to requests for registration with the service and receiving registration-related information, the terminal communication module 51 receives information of various types transmitted from the server 10. Content information used for re-registration is included in the registration-related information.

The terminal control module 52 receives user instructions from the user interface 53 and, while accessing the terminal memory 54, controls the installation of the application, controls the execution of the application, and so on.

The user interface 53 includes a screen interface for displaying various screens to the user, such as screens for messages or content viewing screens, speakers for outputting audio, and an input interface for receiving input from the user, such as a keyboard, a touchscreen panel, and or like. The user interface 53 receives selection operations or various types of information input operations from the user and passes them on to the terminal control module 52.

The terminal memory 54 stores user IDs and the like used in the application. In addition, when the application is downloaded from the application-providing platform, the terminal memory 54 is used for storing this application program. Furthermore, it stores re-registration content information and other information of various types received from the server 10 by the terminal communication module 51.

For example, when the downloaded game application is launched by the terminal control module 52, the re-registration content information issued by the server 10 is received and stored while carrying out registration with this game service in communication with the server 10 over the network 60. In addition, in order to re-register with the application, the terminal control module 52 requests re-registration by selecting the re-registration content information displayed on the user interface 53 and transmitting it to the server 10.

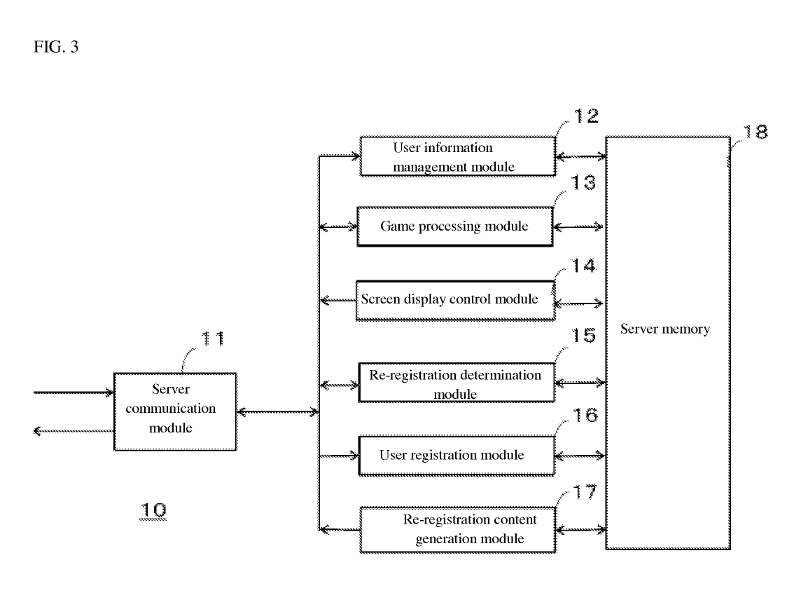

FIG. 3 is a diagram illustrating an exemplary configuration of the server 10 of FIG. 1. This server 10 includes a server communication module 11, a user information management module 12, a game processing module 13, a screen display control module 14, a re-registration determination module 15, a user registration module 16, a re-registration content generation module 17, and a server memory 18. It should be noted that below, for purposes of convenience, the system 100 is described as a game system 100 in which game services are provided.

The server communication module 11 receives a signal transmitted from the user terminal, performs predetermined demodulation processing and sends the demodulated signal to the user information management module 12, game processing module 13, screen display control module 14, re-registration determination module 15, user registration module 16, and re-registration content generation module 17.

In addition, the server communication module 11 receives instructions from the user information management module 12, game processing module 13, screen display control module 14, re-registration determination module 15, user registration module 16, re-registration content generation module 17, and so forth, performs modulation processing on predetermined data, and transmits it to the user terminal.

The term “predetermined data” includes, for example, game-related images, information related to the content information used for re-registration generated by the re-registration content generation module 17, and the like. It should be noted that conventional modulation/demodulation technology may be employed for modulation/demodulation processing in the server communication module 11 and, as will be appreciated by those skilled in the art, the present invention is also applicable to this aspect.

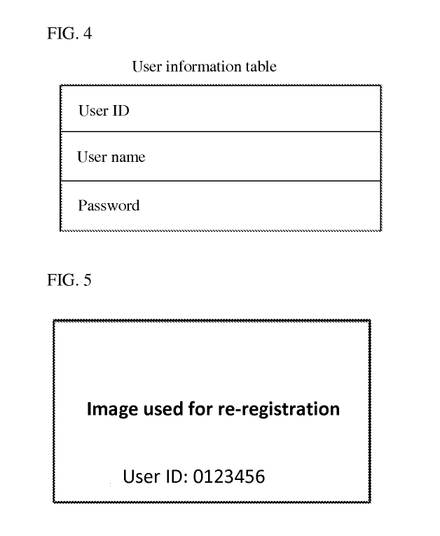

The user information management module 12 manages the information of the users registered with the game system 100 in the server memory 18. For example, as shown in FIG. 4, it manages information such as user identification information (user IDs), user names, passwords, and so forth. Information on these users may be referenced in the game processing module 13 and the like.

In addition to the user information illustrated in FIG. 4, the server memory 18 stores the content information generated by the re-registration content generation module 17 for every registered user.

Upon receiving a request to start a game that can be executed by the game system 100 from a user terminal, the game processing module 13 starts the game and manages the progress of the game. In addition, as the game progresses, the game processing module 13 accesses user information stored in the server memory 18 and executes predetermined processing. The screen display control module 14 exercises control to display predetermined images on the screen of the user terminal in accordance with the progress of the game or based on instructions from the game processing module 13.

The user registration module 16 registers the user in response to a registration request addressed from the user's terminal to the service. In addition, if the re-registration determination module 15 determines that re-registration should be performed, the user registration module 16 registers the user associated with the transmitted content information.

During registration in the user registration module 16, the re-registration content generation module 17 generates content information used for re-registration. At such time, the re-registration content generation module 17 may generate the content information in such a way that the ID information of the user associated with the registration request is included. In addition, the re-registration content generation module 17 may generate the image content information by generating the content information as an image and then superimposing the ID information on the generated image. In addition, the image content information may be generated by superimposing an image having the ID information indicated therein on the above-mentioned image content information.

For example, as shown in FIG. 5, this may be a character indicating that the image is used for re-registration or an image representing a user ID as characters. According to this aspect, users who seek to re-register can promptly recognize the image used for re-registration by checking the content list view on the terminal. This makes it possible to prevent users from forgetting information intended for re-registration.

In addition, instead of user IDs, or along with user IDs, advertisements and the names of the services associated with re-registration, or UUID and other barcode information may be superimposed on the image content used for re-registration in a form recognizable as characters or images, and, in addition, electronically superimposed thereon using electronic watermarking techniques or the like. In accordance with such an aspect, verification is made possible even if the image content used for re-registration is resized or subjected to other binary conversions when sending e-mail. In addition, a proper re-registration process can be implemented in a simple and easy manner based on image verification by incorporating bar-codes, two-dimensional codes, and other bar-code information into the image content used for re-registration.

It should be noted that besides increasing the visibility of the user when searching for the image content for re-registration stored in the user terminal, the incorporation of advertisements into the image content used for re-registration makes it possible to extend invitations on behalf of a service that attracts users through advertisements, as compared to conventional invitational codes that are based on impersonal text data.

According to this aspect, security is improved because login attempts by third parties with conventional character string-based registration IDs (e.g., brute force attacks involving the detection of registration IDs in a round-robin manner) are made more difficult. The level of security can be raised because it is extremely difficult to execute a brute force attack on information superimposed on images.

The re-registration determination module 15 determines whether or not re-registration should be performed by matching content information transmitted from a given user terminal against content information stored in the server memory 18. Specifically, this is determined based on whether there is a match using a technique involving either one of the follow comparisons, or a combination of two or more such comparisons.

(1) Comparing the binary values of the two content information items.

(2) Comparing the hash values of the two items.

(3) Matching by analyzing information superimposed on the content information.

In (1) above, the comparison of binary values makes it possible to correctly determine whether or not the image data are identical. In (2) above, in addition to making it possible to correctly determine whether or not the image data are identical, fraudulent account acquisition due to the fraudulent logins can be minimized because of the difficulty involved in forging images with identical hash values, and security can be enhanced.

In (3) above, reading the “information superimposed on the content information”, such as, for example, user IDs, from the image information and matching it against the user IDs stored in conjunction with the image content information makes it possible to correctly determine that the registration request is from the same user. Furthermore, (3) may be implemented in combination with (1) and/or (2), and in such a case it will be possible to improve security in addition to improving the level of precision in the determination.

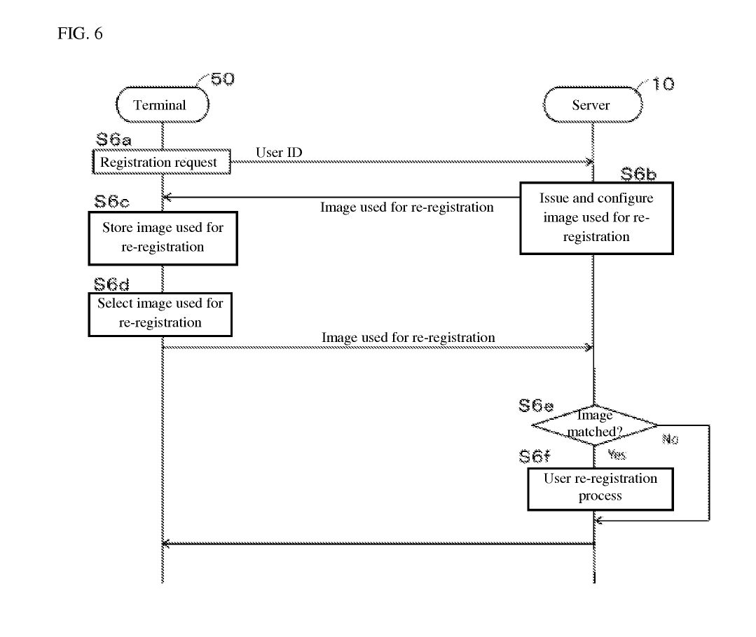

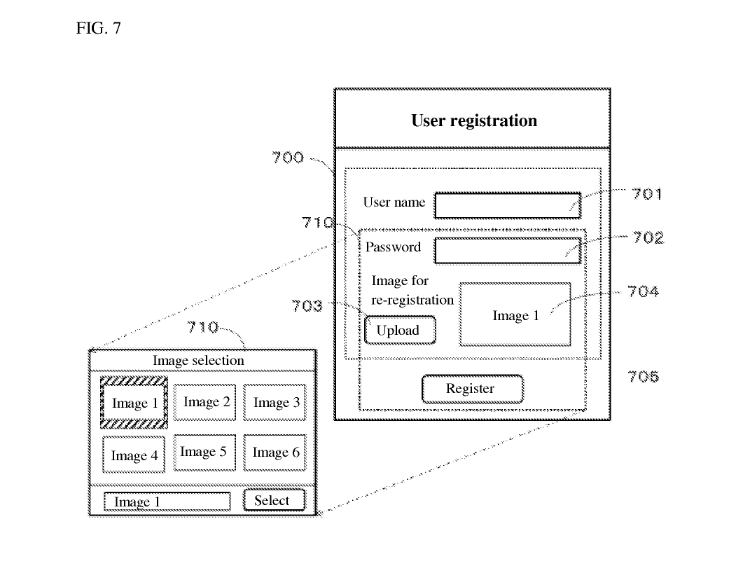

Next, the operation of the system according to Embodiment 1 will be described with reference to FIG. 6 and FIG. 7. FIG. 6 is a sequence diagram illustrating the processing procedure of the system according to Embodiment 1. Here, a case in which the user of a user terminal 50 requests to be registered with the service will be used as an example to facilitate explanation.

In order to request registration with the game service, the user terminal transmits a registration request including a user ID to the server 10 in response to an operation performed by the user (Step S6a). Upon receiving this registration request, the user registration module 16 of the server 10 completes the registration procedure. In addition, the re-registration content generation module 17 of the server 10 issues image content used for re-registration and transmits it to the user terminal (Step S6b). The user terminal stores the received image content in the memory of the terminal (Step S6c). The storage operation may be carried out without waiting for user instructions, or a message to the effect that the content has been stored may be displayed on the screen of the terminal to notify the user terminal 50.

After that, the user, as a result of certain factors, e.g., logging in from a second terminal, or when changing to a different terminal, accesses the memory of the terminal and displays a listing of the image contents on the user interface 53. The user selects the image content used for re-registration from the displayed image content and transmits it to the server 10 (Step S6d).

The server 10 carries out the process for matching the received image content used for re-registration against the image content stored in the memory of the server (Step S6e). If it is determined that a match is found, a user re-registration process is carried out (Step S6f) and the terminal is notified of the re-registration results. If there is no match (“No” in Step S6e), the terminal is notified to that effect and processing is terminated.

FIG. 7 illustrates an example of the user registration screen. The user registration screen 700 includes a user name entry field 701, a password entry field 702, an upload button 703, a selected image display field 704, a register button 705, and an image selection screen 710.

The user name entry field 701 and password entry field 702 can be configured for any combination of numerals, characters, and the like. When the upload button 703 is pressed, the image selection screen 710 is displayed superimposed on the user registration screen 700 and a screen intended for selecting images used for re-registration is displayed. The selected image used for re-registration (here, Image 1) is displayed in the selected image display field 704. When the register button 705 is pressed by the user, the user terminal transmits the above-mentioned entered user and password and the selected image used for re-registration to the server 10, as a result of which a matching process used for re-registration is carried out in the server.

As described above, according to Embodiment 1, information required for re-registration is generated as an image, which makes it possible to implement the process of user re-registration in a simple, easy, and safe manner. In addition, in order to further enhance security, processing intended for identity confirmation, for example, user ID verification, password verification, and verification of registration status in other services provided by the same server 10 may be performed in addition to the uploading and verification of the image used for re-registration.

The present invention has been described above with reference to working examples. The present invention is not limited to the above-described working examples or the content of the working examples, and can be practiced with various modifications within the scope of the present invention. The above-described working examples are illustrative, and it will be appreciated by those skilled in the art that numerous variations thereof are possible based on combining the constituent elements and processing procedures, and that such variations also fall within the scope of the present invention.

### DESCRIPTION OF THE REFERENCE NUMERALS

10 Server
11 Server communication module
12 User information management module
13 Game processing module
14 Screen display control module
15 Re-registration determination module
16 User registration module
17 Re-registration content generation module
18 Server memory
19 Base station
40a First base station
40b Second base station
40c Third base station
50 Mobile terminals
50a First mobile terminal
50b Second mobile terminal
50c Third mobile terminal
60 Network
70 PC terminal
51 Terminal communication module
52 Terminal control module
53 User interface
54 Terminal memory
701 User name entry field
702 Password entry field
703 Upload button
704 Selected image display field
705 Registration button
710 Image selection screen
100 System

1. A server device, which provides a predetermined service to user terminals over a network, wherein the server device is equipped with:
a user registration module that registers a user in response to a registration request addressed from the user's terminal to the service;
a re-registration content generation module that generates content information used for re-registration as an image during registration in the user registration module;
a server memory that stores the content information generated by the re-registration content generation module;
a communication module that transmits the content information generated by the re-registration content generation module in order to store it in the terminal memory of the terminal of the user associated with the registration request;
and a re-registration determination module that determines whether or not re-registration should be performed by matching content information stored in the terminal memory and transmitted from a given terminal of the user against content information stored in the server memory; and,
if the re-registration determination module makes a determination to the effect that re-registration should be performed, the user registration module registers the user associated with the transmitted content information.

2. The server device according to claim 1, wherein the re-registration determination module performs determination by comparing the binary values or hash values of two content information items.

3. The server device according to claim 1, wherein the re-registration content generation module generates content information in such a manner that the ID information of the user associated with the registration request is included.

4. The server device according to claim 3, wherein the re-registration content generation module generates image content information by superimposing ID information on a generated image.

5. A non-transitory computer readable medium having machine-executable instructions with which a computer having a storage and a hardware processor connected via a network to a user terminal device operate in a server device for providing a predetermined service to user terminals over a network, said machine-executable instructions comprising:
a user registration step of registering a user in response to a registration request addressed from the user's terminal to the service;
a re-registration content generation step of generating content information used for re-registration as an image;
a storage step of storing the generated content information in a server memory;
a transmission step of transmitting the generated content information in order to store it in the terminal memory of the terminal of the user associated with the registration request; and
a re-registration determination step of determining whether or not re-registration should be performed by matching the content information stored in the terminal memory and transmitted from a given terminal of the user against the content information stored in the server memory, wherein
the user registration step consists in registering the user associated with the transmitted content information if it is determined during the re-registration determination step that re-registration should be performed.

6. A system equipped with a server device for providing a predetermined service and user terminals connected to the server device over a network, wherein said system is equipped with:
user registration means for registering a user in response to a registration request addressed from the user's terminal to the service;
re-registration content generation means for generating content information used for re-registration as an image during registration in the user registration means;
a server memory that stores the content information generated by the re-registration content generation means;
communication means for transmitting the content information generated by the re-registration content generation means in order to store it in the terminal memory of the terminal of the user associated with the registration request; and
re-registration determination means for determining whether or not re-registration should be performed by matching content information stored in the terminal memory and transmitted from a given terminal of the user against content information stored in the server memory, and
if the re-registration determination means makes a determination to the effect that re-registration should be performed, the user registration means registers the user associated with the transmitted content information.
